(19) United States
(12) Patent Application Publication
(10) Pub. No.: US 2007/0132533 A1
(43) Pub. Date: Jun. 14, 2007

(54) Embedded inductor and manufacturing method thereof

(75) Inventors: Ming-Shan Shiu, Taoyuan Hsien (TW); Robert Lu, Taoyuan Hsien (TW); Sean Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/634,292

(22) Filed: Dec. 6, 2006

(30) Foreign Application Priority Data
Dec. 8, 2005 (TW) 094143295

(51) Int. Cl. H01F 27/02

(52) U.S. Cl. 336/83

(57) ABSTRACT

A manufacturing method of an embedded inductor comprises the steps of: pre-forming a magnetic core having at least two side walls for defining an accommodating space, disposing a coil in the accommodating space of the magnetic core, and pressing the magnetic core for deconstructing and redistributing tops of the side walls to cover the coil.

### DETAILED DESCRIPTION OF THE INVENTION

### Cross Reference to Related Applications

This Non-provisional application claims priority under 35U.S.C. §119(a) on Patent Application No(s). 094143295 filed in Taiwan, Republic of China on Dec. 8, 2005, the entire contents of which are hereby incorporated by reference.

### BACKGROUND OF THE INVENTION

1. Field of Invention

The invention relates to an inductor and a manufacturing method thereof. In particular, the invention relates to an embedded inductor and the manufacturing method thereof.

2. Related Art

As the electronic products become smaller, the sizes of basic and important components such as inductors also have to be shrunk in proportion.

As shown in FIGS. 1 and 2, a conventional embedded inductor 1 includes a pre-formed magnetic core 11, a coil 12, and a magnetic object 13. The magnetic core 11 has one recession 111 and two openings 112, 113. The coil 12 is then disposed in the recession 111. The coil 12 has a first end 121 and a second end 122, extending outward via the openings 112, 113 of the magnetic core 11, respectively, as two pins of the inductor 1. Afterwards, a magnetic powder is inserted and molded to form the magnetic object 13 on the magnetic core 11. This single-piece magnetic core is used to achieve no gap in the inductor 1. However, a junction interface 14 is formed between the magnetic core 11 and the magnetic object 13.

Regarding to the magnetic object 13 of the inductor 1, the thermosetting resin is usually added as an insulating material in addition to the major ingredient of the magnetic powder. This can effectively reduce the core loss phenomenon caused by the eddy current loss.

However, due to the existence of the junction interface 14 between the magnetic core 11 and the magnetic object 13, it is likely to have defects such as cracks. Moreover, the inductance and DC bias of the inductor 1 is worse. If the densities of the magnetic core 11 and the magnetic object 13 are different, then the inductor 1 may break due to thermal stress during the thermally curing process.

Therefore, it is an important subject to provide an embedded inductor and the manufacturing method thereof to simplify the manufacturing procedure and to avoid the defects caused by the existence of the junction interface and the thermal stress problem in materials with different densities.

### SUMMARY OF THE INVENTION

In view of the foregoing, the invention is to provide an embedded inductor with an integrally formed magnetic core and a simple and reliable manufacturing method thereof. It can prevent defects caused by a junction interface and the thermal stress problem due to different material densities, so that the better performance is obtained.

To achieve the above, a manufacturing method of an embedded inductor of the invention comprises the steps of: pre-forming a magnetic core having at least two side walls for defining an accommodating space, disposing a coil in the accommodating space of the magnetic core, and pressing the magnetic core for deconstructing and redistributing the tops of the side walls to cover the coil.

In addition, the invention also discloses an embedded inductor, which comprises a magnetic core and a coil. The magnetic core is formed by directly pressing a single E-shaped body or a single U-shaped body. The coil is embedded inside the magnetic due to the deconstructed and redistributed side walls of the single E-shape or U-shaped body.

As mentioned above, according to a preferred embodiment of the embedded inductor and its manufacturing method, the tops of the side walls of the magnetic core are deconstructed and redistributed to cover the coil. In comparison with the prior art, the invention can simplify the manufacturing procedure of the embedded inductor. The inductor does not have the crack, interface defect or hole defect, so that the inductor does not break due to the thermal stress in different material densities. Therefore, the inductor of the invention can sustain a large current and maintain a sufficient inductance to store energy. Furthermore, the inductance and DC bias of the inductor are also better.

### BRIEF DESCRIPTION OF THE DRAWINGS

The invention will become more fully understood from the detailed description given herein below illustration only, and thus is not limitative of the present invention, and wherein:

FIGS. 1 and 2 are schematic views of a conventional embedded inductor;

FIG. 3 is a flowchart of a manufacturing method of an embedded inductor according to a preferred embodiment; and

FIGS. 4 to 8 are schematic views showing the manufacturing method of the embedded inductor.

### DETAILED DESCRIPTION OF THE INVENTION

The present invention will be apparent from the following detailed description, which proceeds with reference to the accompanying drawings, wherein the same references relate to the same elements.

A manufacturing method of an embedded inductor according to an embodiment of the invention comprises the steps of: pre-forming a magnetic core having at least two side walls for defining an accommodating space, disposing a coil in the accommodating space of the magnetic core, and pressing the magnetic core for deconstructing and redistributing the tops of the side walls to cover the coil.

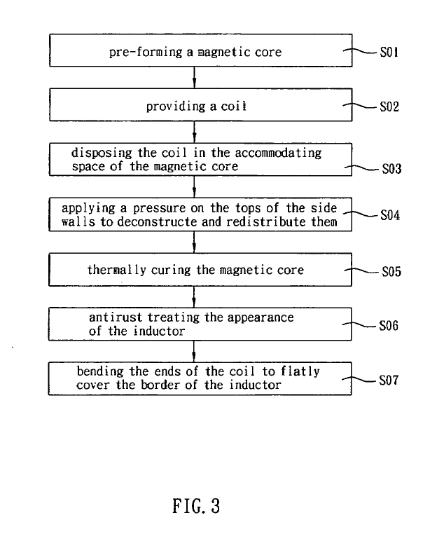

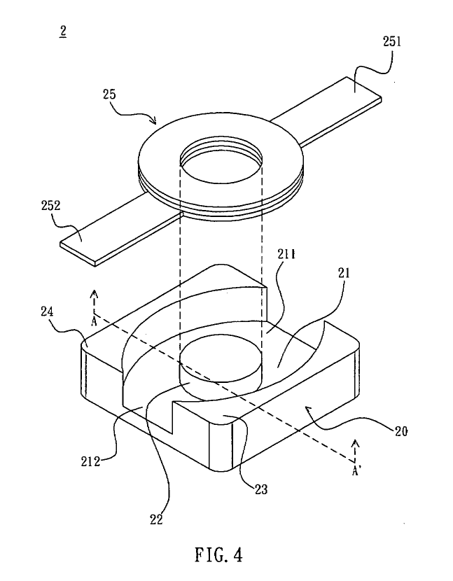

As shown in FIG. 3, the manufacturing method of an embedded inductor 2 comprises steps S01 to S07. The following descriptions also refer to FIGS. 4 to 8.

With reference to FIG. 4, a magnetic core 20 is pre-formed in step S01. The magnetic core 20 has a base 21, a central post 22, and at least two side walls 23, 24. The central post 22 and the side walls 23, 24 are disposed at the center and border of the base 21, respectively. The side walls 23, 24 define an accommodating space. The central post 22 is located at the center of the accommodating space. The two ends of the side wall 23 are not connected with the two ends of the side wall 24 to form openings 211, 212. One of the ends of the side wall 23 can be connected to one of the ends of the side wall 24 with an opening. The magnetic core 20 has an E or U shape formed by pressing the mixture of at least one kind of magnetic metal powders and one kind of thermosetting resin powders. In the embodiment, the magnetic metal powders may be iron powders or iron-based alloy.

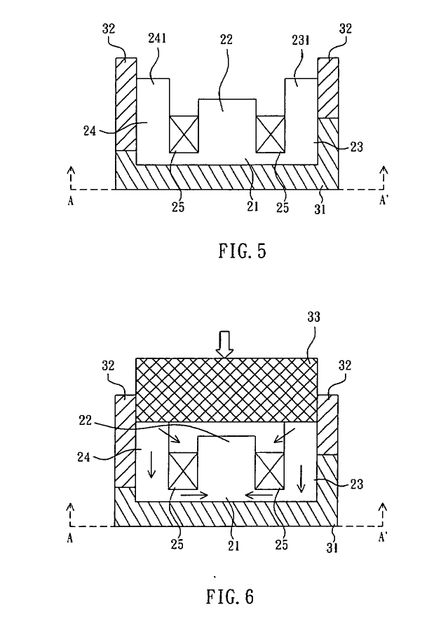

Step S02 provides a coil 25 having a first end 251 and a second end 252. The coil 25 can be antirust treated in advance. As shown in FIGS. 4 and 5, the coil 25 is disposed in the accommodating space of the magnetic core 20 in step S03. The coil 25 is mounted on the central post 22 and rests on the base 21. The magnetic core 20 is disposed in a mold module. The first end 251 and the second end 252 extend via the openings 211, 212 of the magnetic core 20 out of the base 21 as the two terminals of the inductor 2. The mold module consists of a base mold 31 and a fixed mold 32. More explicitly, the base 21 is disposed in the base mold 31. The coil 25 is then disposed on the base 21. Afterwards, the fixed mold 32 is mounted to form the complete mold module.

The coil 25 is tightly combined with the central post 22, so that the coil 25 is positioned at the central of the inductor 2. This prevents the coil 25 from tilting, shifting, breaking, even locally uneven magnetic saturation, increasing the inductance of the inductor 2, and lowering the inductance variation of the inductor 2. Moreover, after the coil 25 is disposed on the magnetic core 20, the first end 251 and the second end 252 can be treated with an antirust process.

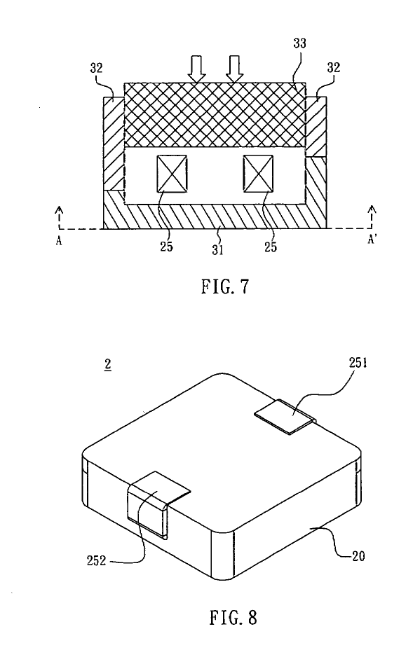

As shown in FIGS. 6 and 7, an upper mold 33 applies a pressure on the tops 231, 241 of the side walls 23, 24 in step S04, so that the tops 231, 241 are deconstructed and redistributed to cover the coil 25 other than the ends 251, 252. In this case, the top of the central post 22 can be deconstructed and redistributed along with the tops 231, 241 according to real needs. The pressure is preferably between 7.0 ton/cm² and 8.0 ton/cm². In this embodiment, for the magnetic core 20 to obtain better material properties after the pressure, the height of the side walls 23, 24 is preferably greater than that of the central post 22. The height difference between the side walls 23, 24 and the central post 22 is preferably between 1.4 mm and 2.0 mm.

In order for the density of the magnetic core 20 to be uniform after the pressure, the density of the central post 22 is greater than the density of the side walls 23, 24. The density of the central 22 is preferably between 4.5 g/cm³ and 5.1 g/cm³, and the density of the side walls 23, 24 is preferably between 4.3 g/cm³ and 4.8 g/cm³. An average density of the magnetic core 20 is preferably no greater than 5.0 g/cm³. For the convenience of transportation, the average density of the magnetic core 20 is preferably between 4.3 g/cm³ and 4.8 g/cm³. Besides, the heights of the side walls 23, 24 and the central post 22 may be equal. In this case, the central post 22 and the side walls 23, 24 are simultaneously deconstructed and redistributed in step S04. Alternatively, the central post 22 may be higher than the side walls 23, 24. In step S04, the central post 22 is deconstructed or redistributed individually or simultaneously with the side walls 23, 24.

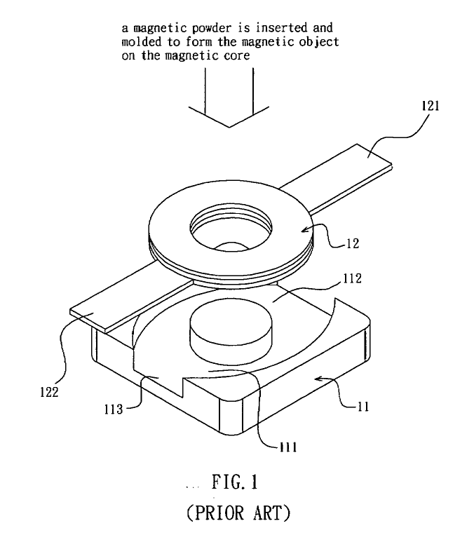

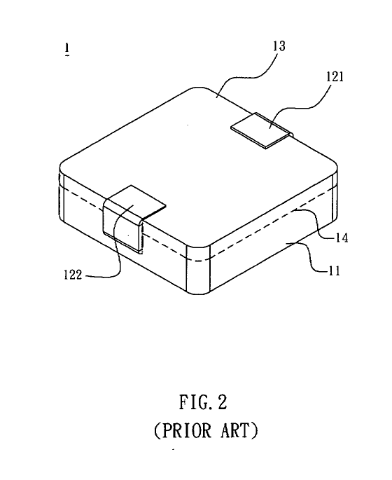

In comparison with FIG. 1, the coil 25 does not need to be filled with magnetic metal powders or inserted with a magnetic object 13. Therefore, the manufacturing procedure of the embedded inductor 2 can be simplified. Besides, due to the compact design of the height and density of the magnetic core 20, its density is uniformly distributed and evenly covers the coil 25. Therefore, it can sustain temperature variations and thus prevent deformations.

In step S05, the magnetic core 20 can be thermally cured, and the temperature of the thermally curing process ranges between 150 and 200. In step S06, the appearance of the inductor 2 is antirust treated. As shown in FIG. 8, the ends 251, 252 are bent in step S07 to flatly cover the border of the inductor 2.

As the ends 251, 252 of the coil 25 need not to be stamped to the same height, the resistance of the coil 25 does not increase. Therefore, the current efficiency of the coil 25 can be enhanced so as to reduce the heat produced by the current flowing through the coil 25.

With reference to FIGS. 4 and 8 again, an embedded inductor 2 according to an embodiment of the invention comprises a magnetic core 20 and a coil 25. The magnetic core 20 is formed by directly pressing a single E-shaped or U-shaped body. The coil 25 is embedded inside the magnetic core 20 by deconstructing and redistributing the side walls 23, 24 of the single E-shaped or U-shaped body. In this embodiment, the magnetic core 20 has an E or U shape.

Moreover, the magnetic core 20 has a base 21, a central post 22, and at least two side walls 23, 24. The central post 22 is disposed at the center of the base 21. The side walls 23, 24 are formed along the border of the base 21. The side walls 23, 24 do not touch one another or touch one another with an opening. Both ends 251, 252 of the coil 25 are exposed outside the magnetic core 20.

Since the embedded inductor of this embodiment is fabricated using the manufacturing method described in the previous embodiment, the details and characters of the method and its effects are not repeated herein again.

In summary, according to a preferred embodiment of the embedded inductor and its manufacturing method, the tops of the side walls of the magnetic core are deconstructed and redistributed to cover the coil. In comparison with the prior art, the invention can simplify the manufacturing procedure of the embedded inductor. The inductor does not have the crack, interface defect or hole defect, so that the inductor does not break due to the thermal stress in different material densities. Therefore, the inductor of the invention can sustain a large current and maintain a sufficient inductance to store energy. Furthermore, the inductance and DC bias of the inductor are also better.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A manufacturing method of an embedded inductor, comprising the steps of:
pre-forming a magnetic core having at least one accommodating space;
disposing a coil in the accommodating space of the magnetic core; and
pressing the magnetic core for deconstructing and redistributing a top of the magnetic core to cover the coil.

2. The manufacturing method of claim 1, wherein the magnetic core comprises at least two side walls for defining the accommodating space.

3. The manufacturing method of claim 2, wherein the magnetic core further comprises a central post disposed in the accommodating space, and the central post and the side walls are disposed at the center and the border of a base, respectively.

4. The manufacturing method of claim 3, wherein both or one of the side walls, the central post is deconstructed and redistributed when pressing the magnetic core.

5. The manufacturing method of claim 1, wherein the step of pre-forming the magnetic core comprises:
mixing at least one magnetic metal powder with a thermosetting resin powder in a mold; and
pressing to form the magnetic core.

6. The manufacturing method of claim 1, wherein a force applied for pressing the magnetic core is between 7.0 ton/cm² and 8.0 ton/cm².

7. The manufacturing method of claim 1, wherein the step of preforming the magnetic core comprises the step of thermally curing the magnetic core, the temperature of the thermally curing process ranging between 150 and 200.

8. The manufacturing method of claim 1 further comprising the step of:
antirust treating ends of the coil.

9. The manufacturing method of claim 1 further comprising the step of:
bending ends of the coil so that the ends are flatly attached on the border of the inductor.

10. An embedded inductor comprising:
a magnetic core formed by directly pressing a single body; and
a coil embedded inside the magnetic core by deconstructing and redistributing walls of the single body.

11. The embedded inductor of claim 10, wherein the single body has an E shape or a U shape.

12. The embedded inductor of claim 10, wherein two ends of the coil are exposed outside the magnetic core.

13. The embedded inductor of claim 10, wherein the single body comprises at least two side walls for defining the accommodating space, and a central post disposed in the accommodating space, wherein the central post and the side walls are disposed at the center and the border of a base, respectively.

14. The embedded inductor of claim 13, wherein each of the side walls has a height greater than or equal to that of the central post.

15. The embedded inductor of claim 13, wherein the height difference between the side walls and the central post ranges between 1.4 mm and 2.0 mm.

16. The embedded inductor of claim 13, wherein the density of the central post is greater than that of the base and/or the side walls, and ranges between 4.5 g/cm³ and 5.1 g/cm³.

17. The embedded inductor of claim 10, wherein an average density of the magnetic core is no greater than 5.0 g/cm³.

18. The embedded inductor of claim 10, wherein an average density of the magnetic core is between 4.3 g/cm³ and 4.8 g/cm³.

19. The embedded inductor of claim 10, wherein the magnetic core is made of a mixture of at least one magnetic metal powder and a thermosetting resin powder.

20. The embedded inductor of claim 19, wherein the magnetic metal powder is an iron powder or an iron-based alloy.
